(19) United States
(12) Patent Application Publication
(10) Pub. No.: US 2010/0289624 A1
(43) Pub. Date: Nov. 18, 2010

(54) APPARATUS FOR COMMUNICATING WITH RFID TAG

(75) Inventor: MITSURU NAKAMURA, NAGOYA-SHI (JP)

Correspondence Address: DAY PITNEY LLP, 7 TIMES SQUARE, NEW YORK, NY, 10036-7311, US

(73) Assignee: BROTHER KOGYO KABUSHIKI KAISHA, Nagoya-shi (JP)

(21) Appl. No.: 12/844,325

(22) Filed: Jul. 27, 2010

Related U.S. Application Data
(63) Continuation-in-part of application No. PCT/JP2009/050519, filed on Jan. 16, 2009.

(30) Foreign Application Priority Data
Jan. 30, 2008 (JP) 2008-019677

(51) Int. Cl. H04Q 5/22

(52) U.S. Cl. 340/10.3

(57) ABSTRACT

The disclosure discloses an apparatus for communicating with an RFID tag of a movable type, comprising: an apparatus antenna configured to conduct information transmission and reception with respect to an RFID tag circuit element; a transmission processing portion configured to generate an inquiry signal for obtaining the information stored and transmits the signal via the apparatus antenna; a reception processing portion configured to be able to receive a response signal replied from the RFID tag circuit element via the apparatus antenna; a notifying device configured to make notification according to a reception result; and a notification control portion configured to control the notifying device so that the notification by the notifying device is in a mode corresponding at least to movement of the apparatus before the notification of the notifying device is started after the reception processing by the reception processing portion is performed.

### CROSS-REFERENCE TO RELATED APPLICATION

This is a CIP application PCT/JP2009/50519, filed Jan. 16, 2009, which was not published under PCT article 21(2) in English.

### BACKGROUND OF THE INVENTION

1. Field of the Invention

The present invention relates to an apparatus for communicating with a radio frequency identification (RFID) tag that reads information from an RFID tag capable of radio communication of information with the outside.

2. Description of the Related Art

A radio frequency identification (hereinafter referred to as RFID) system that reads and writes information with respect to a small-sized RFID tag is known. A reader/writer disposed in the RFID system transmits an inquiry to an RFID tag and receives a reply in a non-contact manner.

There is an apparatus for communicating with an RFID tag that smoothly conducts communication with an RFID tag circuit element used in such RFID system.

With this prior art reference, a tag reader as an apparatus for communicating with an RFID tag is mounted on an article management robot. The tag reader reads information transmitted from an ID tag as an RFID tag circuit element. By means of cyclic movement of the article management robot, the apparatus for communicating with an RFID tag mounted on the article management robot detects an RFID tag circuit element disposed in each article. Then, the position of the article is detected based on the position of the article management robot at the detection, and the detected position is notified to an operator by a display.

However, the above-described prior art reference has the following problems.

That is, there is a case that an operator uses a handheld apparatus for communicating with an RFID tag in a warehouse, for example. In this case, in order to detect an RFID tag circuit element disposed in each of a plurality of articles, that is, in order to obtain information, the operator often carries the apparatus for communicating with an RFID tag in the hand and swings it around when communication is conducted. If a direction of information transmission and reception by the apparatus for communicating with an RFID tag is on an apparatus front side, for example, a front direction of the apparatus for communicating with an RFID tag when information can be obtained from the RFID tag circuit element becomes a direction where the corresponding RFID tag circuit element is present. Therefore, when the information is obtained, if the apparatus for communicating with an RFID tag notifies the operator of the information obtainment, the operator can gain knowledge of the presence direction of the RFID tag circuit element, that is, the presence direction of the article.

As described above, if a signal is received from the RFID tag circuit element and it is notified to the operator, actually there is a time delay till the notification in the apparatus for communicating with an RFID tag. The time delay is a delay caused by processing time for reception processing of a response signal from the RFID tag circuit element, operation time of notification means for making notification after the processing, for example. If the movement or a change in the direction of the apparatus for communicating with an RFID tag is relatively fast, even while the above-described slight processing time and operation time, for example, elapsed, the apparatus for communicating with an RFID tag can largely progress. The operator's swinging operation corresponds to the fast movement and change in the direction. Thus, there can be a deviation between the position or direction of the apparatus for communicating with an RFID tag when a signal is received from the RFID tag circuit element and the position or direction of the apparatus for communicating with an RFID tag when the processing has been finished and that is notified by the notification means. In this case, there is a fear that substantially accurate notification cannot be made to the operator.

With the apparatus of the prior art reference, the time delay that can be caused with respect to the fast movement of the apparatus for communicating with an RFID tag from signal reception to notification is not particularly assumed. Therefore, it has been difficult to make accurate notification in response to the signal reception in the above case.

### SUMMARY OF THE INVENTION

An object of the present invention is to provide an apparatus for communicating with an RFID tag that can make accurate notification to an operator in response to the signal reception from the RFID tag circuit element.

### BRIEF DESCRIPTION OF THE DRAWING

FIG. 1 is a diagram illustrating an example when a reader of an embodiment of the present invention is applied to a search of a book contained in a bookcase.

FIG. 2 is a system configuration diagram illustrating an outline of the reader.

FIG. 3 is a block diagram illustrating an example of a functional configuration of an RFID tag circuit element disposed in an RFID tag.

FIG. 4 is an explanatory diagram for conceptually explaining detection of the RFID tag and timing and a positional relationship of notification when the reader and a communicable area are moved.

FIG. 5 is a flowchart illustrating a control procedure executed by a CPU of the reader.

FIG. 6 is a diagram illustrating an example of notification contents displayed on a display part.

FIG. 7 is a diagram illustrating an example of the notification contents displayed on the display part.

FIG. 8 is a diagram illustrating an example of the notification contents if the display part is configured by an LED.

FIG. 9 is an explanatory diagram for conceptually explaining the detection of the RFID tag and the timing and positional relationship of the notification in a variation in which a detected position deviation is calculated in a predetermined processing time.

FIG. 10 is a flowchart illustrating a control procedure executed by the CPU of the reader in a variation in which the detected position deviation is calculated in the predetermined processing time and corresponding to FIG. 5.

FIG. 11 is an explanatory diagram for conceptually explaining the detection of the RFID tag and the timing and positional relationship of the notification in a variation in which the detected position deviation is calculated considering a response delay time.

FIG. 12 is a flowchart illustrating a control procedure executed by the CPU of the reader in a variation in which the detected position deviation is calculated, reflecting a response delay time, and corresponding to FIG. 5.

FIG. 13 is a flowchart illustrating a control procedure executed by the CPU of the reader in a variation in which a notification checking operation is performed and corresponding to FIG. 5.

### DETAILED DESCRIPTION OF THE PREFERRED EMBODIMENTS

An embodiment of the present invention will be described below referring to the attached drawings.

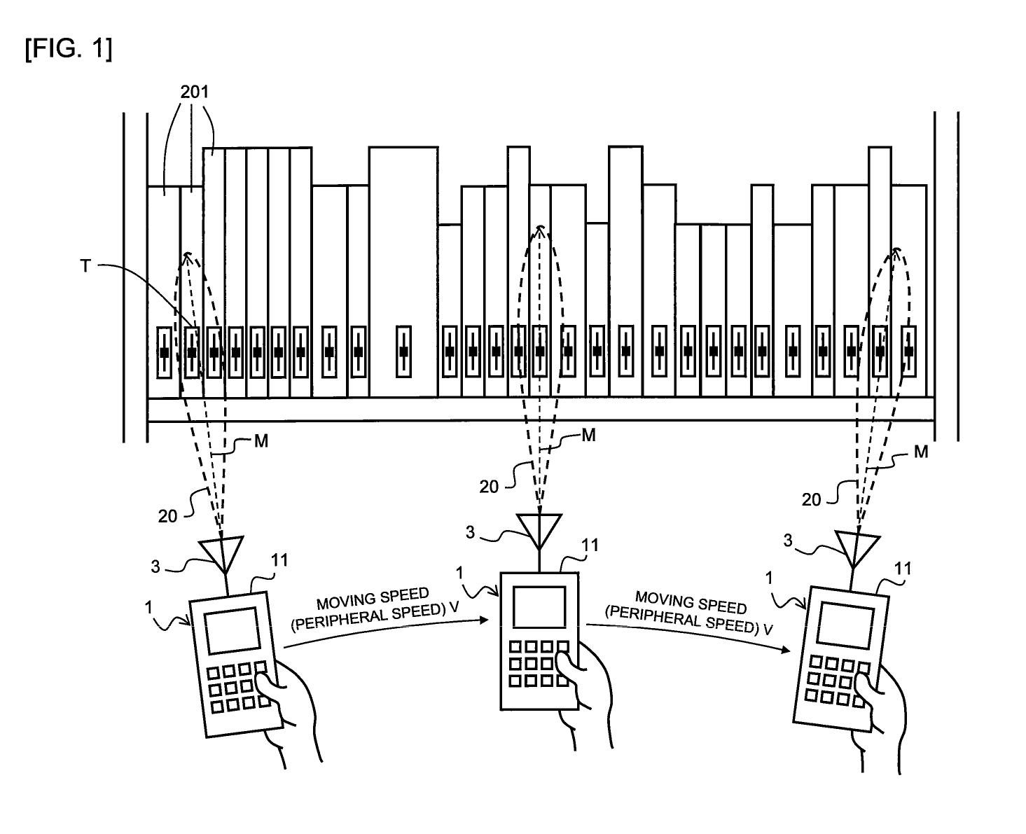

As shown in FIG. 1, in this example, on a shelf board in a bookcase, a plurality of books 201 are aligned and stored in the horizontal direction, that is, in the right-and-left direction in the figure. In this example, the book 201 is stored in a vertically placed state in which its spine is held vertically. On the spines of the books 201, RFID tags T are attached with the same orientation, respectively. In the illustrated example, each of the RFID tags T is attached with the longitudinal directions held vertically.

A reader 1, which is an apparatus for communicating with an RFID tag of this embodiment is a movable type and a handheld type in this example. The reader 1 has a housing 11 generally formed in a rectangular solid shape and a reader antenna as an apparatus antenna. The reader antenna 3 in this example has a sharp directivity. That is, a half power angle of the reader antenna 3 is small and the width of a communicable area 20 is small. Moreover, a main lobe direction M of the reader antenna 3 substantially matches the longitudinal direction of the housing 11.

An operator of the reader 1 is an administrator of the book 201, for example. The operator moves the reader 1 substantially along the direction where the plurality of books 201 are aligned by carrying the reader 1 in the hand and by moving it by swinging the arm substantially in the arc state, for example. The present invention can be applied to the case in which the reader 1 moves linearly or makes a circular motion. By means of this movement, the communicable area 20 of the reader antenna 3 passes an alignment range of the plurality of books 201 at a moving speed V. The moving speed is a peripheral speed in this example. Also, the RFID tag T attached to the search target book will be referred to as a target tag Tt as appropriate. If the target tag Tt is located in the longitudinal direction of the housing 11, which is a reference search direction of the reader 1, that is, in the vicinity of the main lobe direction of the reader antenna 3, identification information of the target tag Tt is received via radio communication through the reader antenna 3. The identification information of the target tag Tt will be referred to as a target tag ID as appropriate. As a result, the reader 1 can detect the presence position of the search target book or the presence direction from the reader 1.

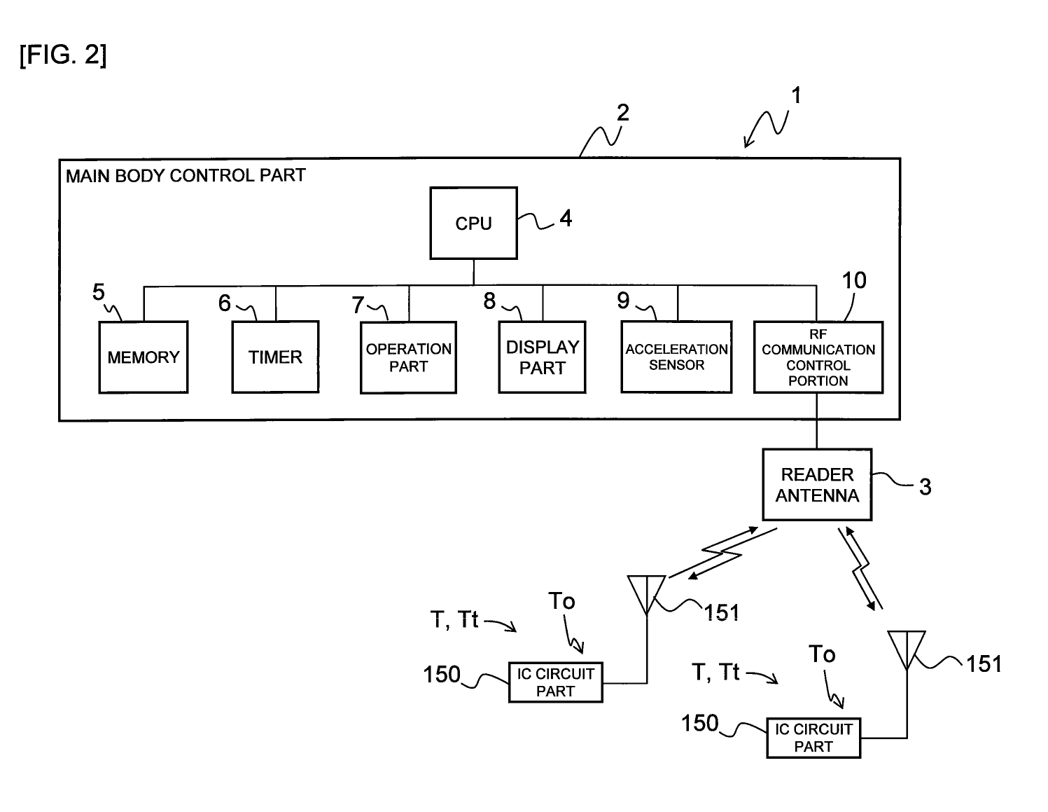

As shown in FIG. 2, the reader 1 has a main body control part 2 disposed in the housing 11 and the reader antenna 3.

The main body control part 2 includes a CPU 4, a memory 5, a timer 6, a display part 8 as a notification device, an acceleration sensor 9 as a movement detecting device, the memory 5 including a RAM and a ROM, for example, the timer 6 having a clocking function, and a radio frequency (RF) communication control portion 10. An operation part 7 receives an input of an instruction and information from the operator. The display part 8 displays various types of information and messages. The acceleration sensor 9 detects movement acceleration when the reader 1 moves. The RF communication control portion 10 controls radio communication with the RFID tag T through the reader antenna 3.

The CPU 4 performs signal processing according to a program stored in the ROM in advance using a temporary storage function of the RAM. The CPU 4 performs various controls of the entire reader 1 by the signal processing.

The acceleration sensor 9 is a triaxial acceleration sensor such as a MEMS type using a known piezo resistance method or an electrostatic capacity method, for example. In this example, the acceleration sensor 9 individually detects moving acceleration in directions corresponding to the width direction, the length direction, and the thickness direction of the housing 11 of the main body control part 2 in the reader 1, respectively, that is, the moving acceleration in the coordinate axis directions in the housing 11. The width direction of the housing 11 corresponds to the right-and-left direction in FIG. 1. The CPU 4 integrates the acceleration in each axial direction detected by the triaxial acceleration sensor 9 by a calculation such as a known integration method, respectively. As a result, the CPU 4 calculates a moving speed component corresponding to each direction of the reader 1 with a sign, respectively. That is, in other words, the CPU 4 calculates the moving amount component per time of the reader 1 including the moving direction of the reader 1. An angular speed sensor may be used instead of the acceleration sensor 9.

As the display part 8, in this example, an LCD which can display a text such as characters or symbols or figures, that is, a liquid crystal display is used. An example using other types of display part or notification device will be described later.

The RFID tag T has an RFID tag circuit element To provided with a tag antenna 151 and an IC circuit part 150. The RFID tag T has the RFID tag circuit element To disposed on a base material, for example, not particularly shown. The RFID tag T can be attached to an article such as the book 201.

Also, the CPU 4 processes a signal read from an IC circuit part 150 of the RFID tag circuit element To and reads information and generates a response request command to make an access to the IC circuit part 150 of the RFID tag circuit element To.

The reader antenna 3 has a sharp directivity as described above. That is, the communicable area 20 of the reader antenna 3 is formed in a narrow width and with an elongated shape in the main lobe direction. Also, the main lobe direction of the reader antenna 3 matches the longitudinal direction of the housing 11 of the reader 1. As a result, the reader 1 can conduct radio communication only with respect to the RFID tag T present in the vicinity on an extension in the longitudinal direction of the housing 11 as shown in FIG. 1.

The RF communication control portion 10 makes an access to information of the IC circuit part 150 of the RFID tag circuit element To through the reader antenna 3, that is, the RFID tag information including the tag ID.

By using the RF communication control portion 10, the reader 1 transmits the response request command to the RFID tag circuit elements To of the RFID tags T present in the communicable area 20. The response request command functions as an inquiry signal requesting transmission of the tag ID of each of the RFID tag circuit elements To as a response signal.

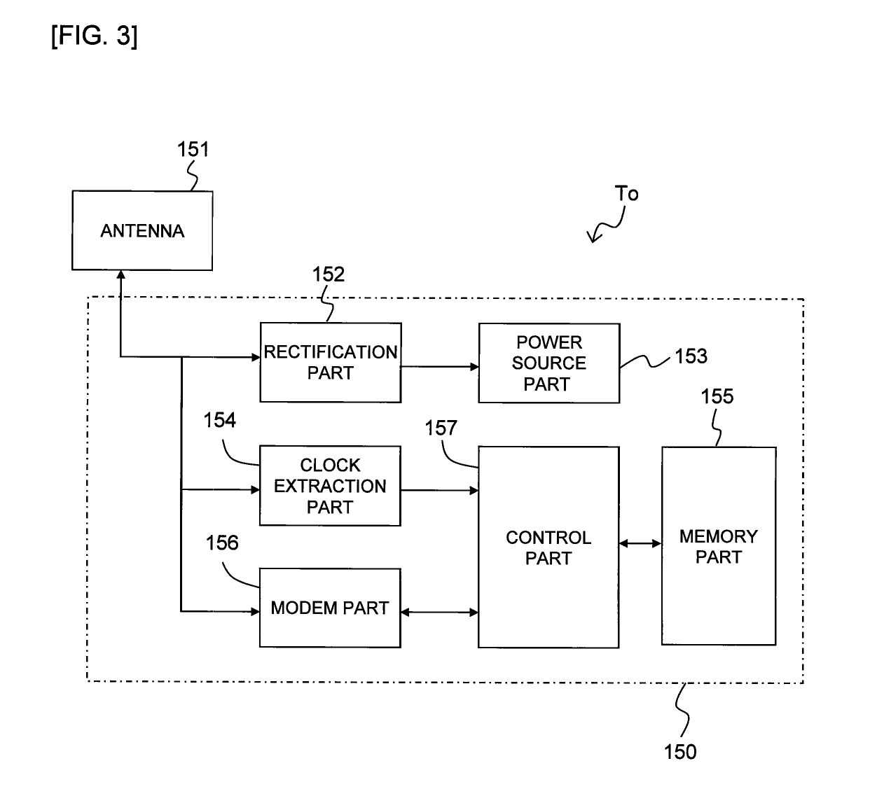

As shown in FIG. 3, the RFID tag circuit element To includes the tag antenna 151 and the IC circuit part 150. The tag antenna 151 performs signal transmission and reception in a non-contact manner with the reader antenna 3 of the reader 1 as described above. The IC circuit part 150 is connected to the tag antenna 151.

The IC circuit part 150 includes a rectification part 152, a power source part 153, a clock extraction part 154, a memory part 155, and a control part 157. The rectification part 152 rectifies an interrogation wave, which is a signal including the response request command, received by the tag antenna 151. The power source part 153 accumulates energy of the interrogation wave rectified by the rectification part 152 and uses the energy as a driving power source. The clock extraction part 154 extracts a clock signal from the interrogation wave received by the tag antenna 151 and supplies the signal to the control part 157. The memory part 155 stores a predetermined information signal. The control part 157 controls operations of the RFID tag circuit element To through the memory part 155, the clock extraction part 154, and the modem part 156, for example.

The modem part 156 demodulates a communication signal from the reader antenna 3 of the apparatus for communication with an RFID tag 1, received by the tag antenna 151 and also modulates a reply signal from the control part 157 and transmits it from the tag antenna 151 as a response wave as a response signal including a tag ID.

The clock extraction part 154 extracts a clock component from the signal received by the tag antenna 151 and extracts the clock to the control part 157. The clock extraction part 154 supplies the clock corresponding to a frequency of the clock component of the signal received by the tag antenna 151 to the control part 157.

The control part 157 interprets a received signal demodulated by the modem part 156 and generates a reply signal on the basis of the information signal stored in the memory part 155. This reply signal is modulated by the modem part 156 on the basis of control of the control part 157 and replied from the tag antenna 151. Here, if the received signal is the response request signal, the control part 157 generates a reply signal including the tag ID stored in the memory part 155 in advance, that is, a response signal. The tag ID is identification information assigned to individual RFID tag circuit element To. The generated response signal is replied from the tag antenna 151.

Subsequently, various timings and positional relationships relating to detection of the target tag Tt and notification of the fact while the reader 1 is moving will be described.

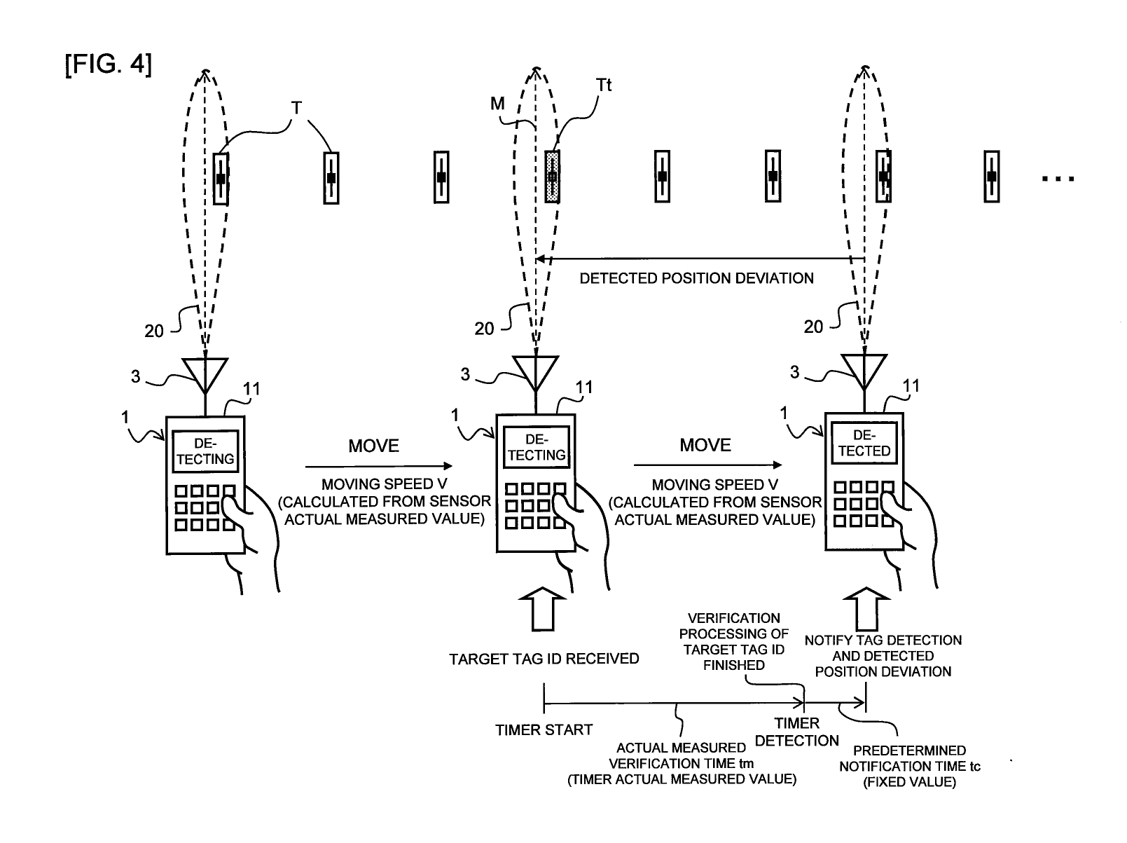

The timings and positional relationships of the detection and notification of the target tag Tt when the reader 1 and its communicable area 20 are moving will be described using FIG. 4. However, though the reader 1 is swung around in an arc state as described above, the movement of the reader 1 is depicted linearly for facilitation of understanding in FIG. 4.

In FIG. 4, the reader 1 moves from one end side of an RFID tag row to the other end side while the communicable area 20 extending from the reader antenna 3 is directed to the RFID tag row consisting of a large number of the RFID tags T. During the movement, by repeating transmission of the response request command and reception of the response signal from each RFID tag T, the tag ID of each RFID tag T is read.

Also, during the movement of the reader 1, an acceleration detected value with a sign corresponding to each axial direction from the triaxial acceleration sensor 9 is integrated by interruption processing executed all the time since start of the movement, for example. As a result, a moving speed V as a moving state amount of the reader 1 during movement caused by arm swinging of the operator or the peripheral speed V in the case of the arc-state movement, for example, is calculated on a real-time basis.

If the communicable area 20 of the reader antenna 3 moving with the reader 1 reaches a presence position of the target tag Tt, the target tag ID is received by the reader 1 via radio communication. At the position of the reader 1 at that time, the target tag Tt is present the closest in the reference search direction of the reader 1, that is, in the longitudinal direction of the housing 11. Therefore, this position should have been confirmed and notified as a detected position where the target tag Tt is detected.

However, at this time, the reader 1 has merely read the target tag ID. Actually, predetermined reception processing such as verification processing to confirm that the read target tag ID is actually a search target, for example, is required after that. In the radio communication in compliance with the Class1 Generation2 (C1G2) stipulated by the EPC global, the tag ID is received from the RFID tag T in an extremely short time. In this case, for example, in the verification processing, the target tag ID is verified for each of the continuously received plurality of tag IDs, and determination is made on whether they are matched or not. Also, if a plurality of target tag IDs as search targets are set in a list, not shown, for example, it is verified if each of the plurality of received tag IDs matches the plurality of target tag IDs set in the list or not.

If reception of the target tag ID is checked after the verification processing requiring a predetermined processing time as above, the reception of the target tag ID, that is, position detection of the target tag ID is notified to the operator through a notifying device such as the display part 8 at that time. Moreover, in the notification operation, after an operation time of the display part 8, which is the notifying device, has elapsed, a notification that can be actually recognized by the operator is made. As the display part 8, a liquid crystal panel, for example, is used.

If the movement of the reader 1 is relatively fast as the search of the reader 1 by arm swinging of the operator, the reader 1 moves even during a slight elapsed time such as an execution time of the reception processing such as the verification and the operation time for notification, for example. As a result, the notification of the RFID tag detection by the display part 8 is made at a position away from the position where the reader 1 actually receives the target tag ID by a distance moved while the verification processing and the notification operation are performed. This separation distance is a distance along the arc-state orbit in the case of the above-described arc-state movement. This separation distance will be referred to as “detected position deviation” as appropriate. In this case, the presence position of the target tag Tt, that is, a containment position of the book 201 as a search target in the example shown in FIG. 1 is largely deviated from the reference search direction of the reader 1. As a result, the operator cannot visually confirm the search target book 201.

Then, in this embodiment, an elapsed time from the reception of the target tag ID till the verification processing is finished is actually measured as an actual measured verification time tm by the timer 6. Also, the time estimated to be required for the notification operation is set in advance as a predetermined notification time tc, which is a fixed time. Then, the detected position deviation is calculated by integrating the moving speed V of the reader 1 with a total time of the actual measured verification time tm, which is the actual measured value, and the predetermined notification time tc, which is a fixed value. The total time corresponds to a first time state amount in this example, and the detected position deviation corresponds to a direction state amount. In the notification operation by the display part 8, the detected position deviation together with the notification of tag detection is displayed on the display part 8.

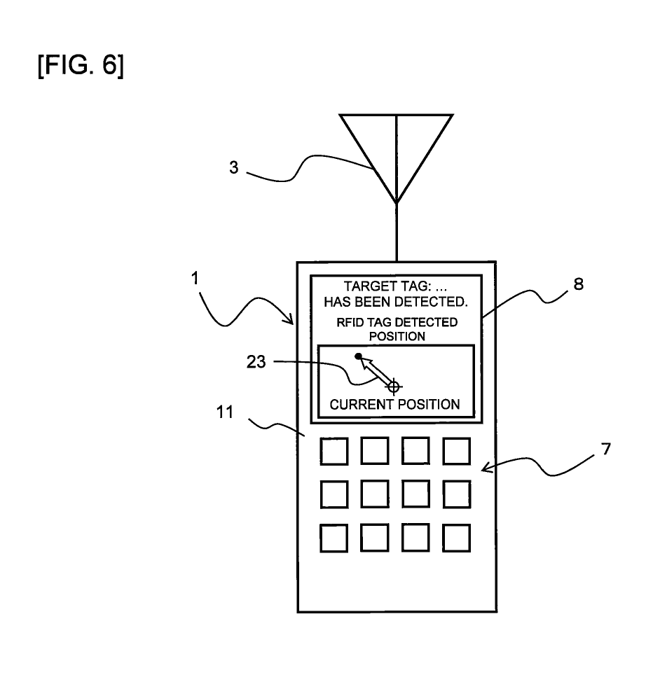

The predetermined notification time tc is set also including the time estimated to be required for the calculation of the detected position deviation, for example. Also, the detected position deviation is expressed by a direction from the current position of the reader 1 (See FIG. 6, for example, which will be described later).

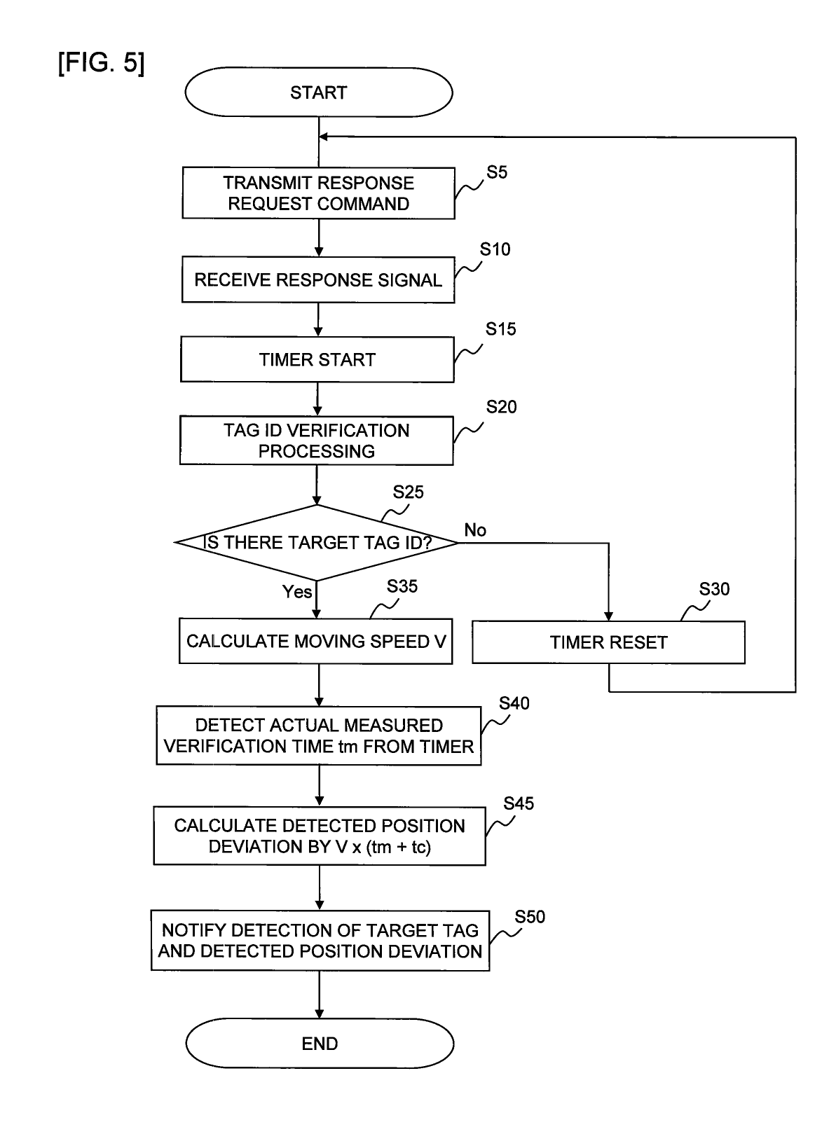

Subsequently, a control procedure executed in the reader 1 of this embodiment will be described using FIG. 5. In FIG. 5, in this example, after the power is turned on or if an operation to start search processing of the target tag Tt is performed in the operation part 7, for example, this flow is started.

First, at Step S5, the CPU 4 outputs a control signal to the above-described transmitting circuit 212 for transmission of the response request command signal for reading of the tag ID. That is, the transmitting circuit 212 performs predetermined modulation so as to generate the response request command signal as an inquiry signal in this example. This response request command signal is an interrogation wave to obtain the tag ID stored in the RFID tag circuit element To of the target tag Tt as described above. The transmitting circuit 212 transmits the response request command signal to the RFID tag circuit element To of the RFID tag T present within the communicable area 20 through the reader antenna 3.

After that, at Step S10, the CPU 4 takes in the response signal transmitted from the RFID tag circuit element To of the RFID tag T in response to the response request command signal and received through the reader antenna 3, that is, the reply signal including the tag ID through a receiving circuit 213.

Subsequently, the routine goes to Step S15, and the CPU 4 starts a clocking operation by outputting a control signal to the timer 6. After that, the routine goes to Step S20.

At Step S20, the CPU 4 performs tag ID verification processing to verify if the tag ID obtained at Step S10 matches the target tag ID, which is the search target.

Subsequently, the routine goes to Step S25, and the CPU 4 determines if the target tag ID has been detected or not in the tag ID verification processing at Step S20. In other words, the CPU 4 determines if at least one of the tag IDs received at Step S10 matches the target tag ID or not. If the target tag ID has not been detected, the determination is not satisfied, and the routine goes to Step S30. At Step S30, the CPU 4 resets the clocking contents so far by stopping the operation of the timer 6, returns to Step S5 and repeats the similar procedure. As a result, if a response signal including a plurality of tag IDs is received at Step S10, the verification is repeated in the tag ID verification processing at Step S20 till the received response signal includes the tag ID which matches the target tag ID. If a plurality of the target tag IDs are set as the search targets, the verification is repeated till the received response signal includes the plurality of tag IDs which match all the plurality of target tag IDs.

On the other hand, at Step S25, if the target tag ID has been detected, the determination is satisfied, and the routine goes to the subsequent Step S35.

At Step S35, the CPU 4 calculates the moving speed V of the reader 1 at this point of time. In the calculation of the moving speed V, as described above, the CPU 4 executes interruption processing with a small time interval from the moving start of the reader 1, for example, cumulatively integrates the acceleration with a sign detected by the triaxial acceleration sensor 9, respectively, corresponding to each axial direction by a known integration method and calculates the speed.

Subsequently, the routine goes to Step S40, and the CPU 4 obtains clocking contents of the timer 6 at this time, by which the CPU 4 obtains the actual measured verification time tm, which is an actual measured value from the reception of the target tag ID at S10 to this point of time. While only a usual tag ID, which is not the target tag ID, is continuously received, the timer 6 is kept on being reset at Step S25 and Step S30.

Then, at the subsequent Step S45, the CPU 4 calculates the detected position deviation or a distance on the arc-state orbit in this example. That is, the CPU 4 calculates the total time of the actual measured verification time tm obtained at Step S40 first and the predetermined notification time tc set in advance as a fixed value. This Step S45 functions as a time calculating device described in each claim. The CPU 4 integrates the moving speed V of the reader 1 calculates at Step S35 with the total time so as to calculate the detected position deviation. The direction of the detected position deviation has a sign opposite to the sign of the moving speed V, that is, the direction is opposite to the moving direction of the reader 1.

Subsequently, the routine goes to Step S50, and the CPU 4 outputs a control signal to the display part 8. As a result, the fact that the target tag ID has been received and the presence direction of the target tag Tt, which is the original search target, corresponding to the distance and direction of the detected position deviation calculated at Step S45 are displayed on the display part 8. The presence direction of the target tag Tt is acquired by the CPU 4 through a predetermined calculation on the basis of the distance and direction of the detected position deviation at Step S45. As a result, notification is made to the operator. And this flow is finished.

If the notification is to be made, display as shown in FIG. 6, for example, is made on the display part 8 including a liquid crystal panel. That is, on the display part 8, text information notifying the contents of the target tag ID and the fact of the detection and an arrow 23 drawn from the current position of the reader 1 as a starting point are shown. The text information corresponds to the display contents on an upper side of the display part 8 in the figure. The direction of the arrow 23 indicates the presence position direction of the target tag Tt.

Here, the predetermined notification time tc used for the calculation at Step S45 is, as described above, a fixed value set in advance as time usually required from acquisition of the actual measured verification time tm at Step S40 to completion of the notification operation at Step S50. That is, the predetermined notification time tc includes both the time estimated as necessary for the calculation at Step S45 and the time estimated as necessary for display in the notification operation at Step S50.

In the above, the procedure at Step S5 in the flow of FIG. 5 functions as a transmission processing portion described in each claim. The procedure at Step S10 functions as a reception processing portion. The calculation contents for calculating the total time of the actual measured verification time tm and the predetermined notification time tc function as a time calculation portion as described above in Step S45.

Also, in Step S45, the calculation contents for calculating a detected position deviation by integrating the moving speed V with the total time function as a direction calculation portion. This function and the procedure at Step S50 function as a notification control portion.

As described above, in this embodiment, in response to the deviation between the position of the reader 1 when the target tag ID is received and the position of the reader 1 when notification is actually made to the display part 8, the display part 8 displays the presence direction of the target tag Tt and notifies it to the operator. As a result, the notification corresponding to the reception result of the target tag ID with accuracy, that is, the notification matching the timing of reception of the response signal can be reliably made to the operator.

Also, particularly in this embodiment, at Step S45, the CPU 4 calculates the total time of the actual measured verification time tm detected as an actual measured value from the timer 6 and the predetermined notification time tc, which is a fixed value and calculates a detected position deviation using the total time and the moving speed V of the reader 1. As a result, calculation and notification of the detected position deviation with high accuracy can be made.

Also, particularly in this embodiment, the reader 1 includes the triaxial acceleration sensor 9 which can detect the moving acceleration of the reader 1. As a result, without requiring an external aiding facility, the reader 1 can singularly detect the moving acceleration of the reader 1 from the triaxial acceleration sensor 9 and calculate the moving speed V.

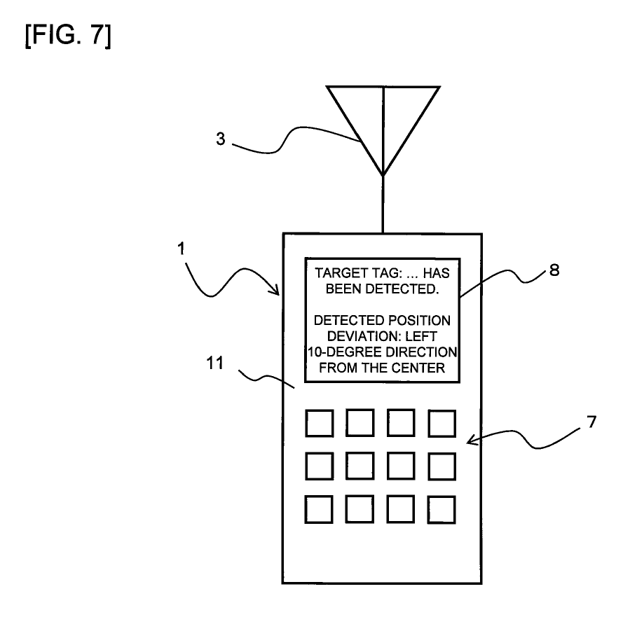

In the above embodiment, as shown in FIG. 6, the display part 8 of the reader 1 indicates the presence direction of the target tag Tt by an arrow, but not limited to that. As shown in the display contents on a lower side of the display part 8 in FIG. 7, for example, the presence direction of the target tag Tt can be displayed in text information. In this example, a deviation amount in a center line direction of the reader 1 expressed in the vertical direction in FIG. 7, that is, in the right-and-left direction of the target tag Tt from the reference search direction is indicated as “left 10-degree direction”.

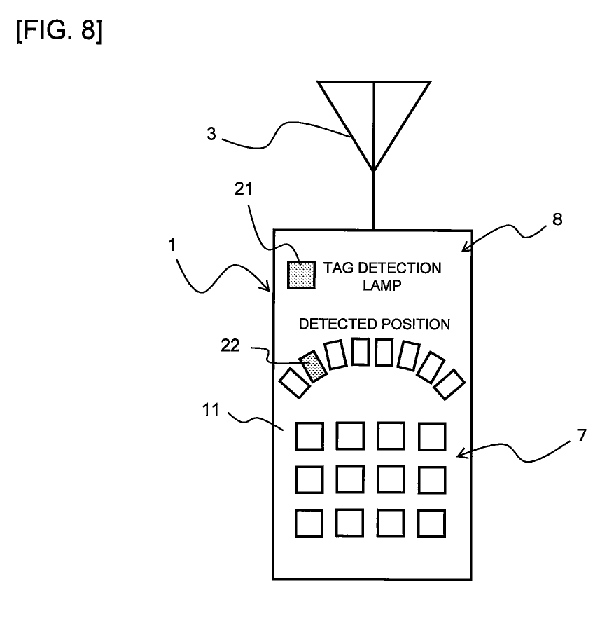

Also, as shown in FIG. 8, for example, the notification may be made by a lighting state of the display part 8 including an LED. In the illustrated example, the display part 8 includes a single LED 21 that notifies presence of detection of the target tag Tt and a plurality of LED arrays 22 disposed in an arc state corresponding to the detected position deviations, respectively. In this case, the presence direction of the target tag Tt can be easily notified only by lighting of one LED. As a result, as compared with the notification by an arrow indication or text indication by the liquid crystal panel, time required for the notification operation is short. That is, the predetermined notification time tc gets short.

In addition to the above, though not particularly illustrated, notification can be made to the operator by a sense of touch by disposing a vibration oscillator such as a vibrator in the housing 11 of the reader 1 and using the vibration or notification can be made to the operator by a sense of hearing by disposing a sound generator such as a speaker and using sound. In these cases, it may be configured that a plurality of vibration oscillators or sound generators are disposed at positions corresponding to each direction of the detected position deviation, respectively, so that the direction of the detected position deviation can be distinguished. Alternatively, the distance of the detected position deviation can be expressed by a difference in a size of amplitude or a height of frequency of the respective vibration or sound. If the sound generator is to be used, various types of notification information may be uttered by human language.

Also, the reader 1 may include a plurality of notifying devices in a comprehensive manner. In this case, since a required time for the notification operation is different depending on the type of the notification, that is, the predetermined notification time tc which is different corresponding to the notification type of each notifying device is set. In this case, at the above-described Step S45, the predetermined notification time tc corresponding to the notification type is selected and used so as to calculate the detected position deviation. As a result, the total time of the actual measured verification time tm and the predetermined notification time tc are also selected corresponding to the notification type. For example, the operator may input which notification type is to be selected in advance by using the operation part 7. As described above, by setting the predetermined notification time tc according to the notification type such as sound, display, vibration, detailed notification of the detected position deviation is made possible, and convenience for the operator can be improved.

The present invention is not limited by the above embodiments but capable of various deformations within a range not departing from its gist and technical idea. Such variations will be described below in order.

(1) If the Entire Time from Reception of the Target Tag ID to Start of the Notification Operation is Fixedly Set:

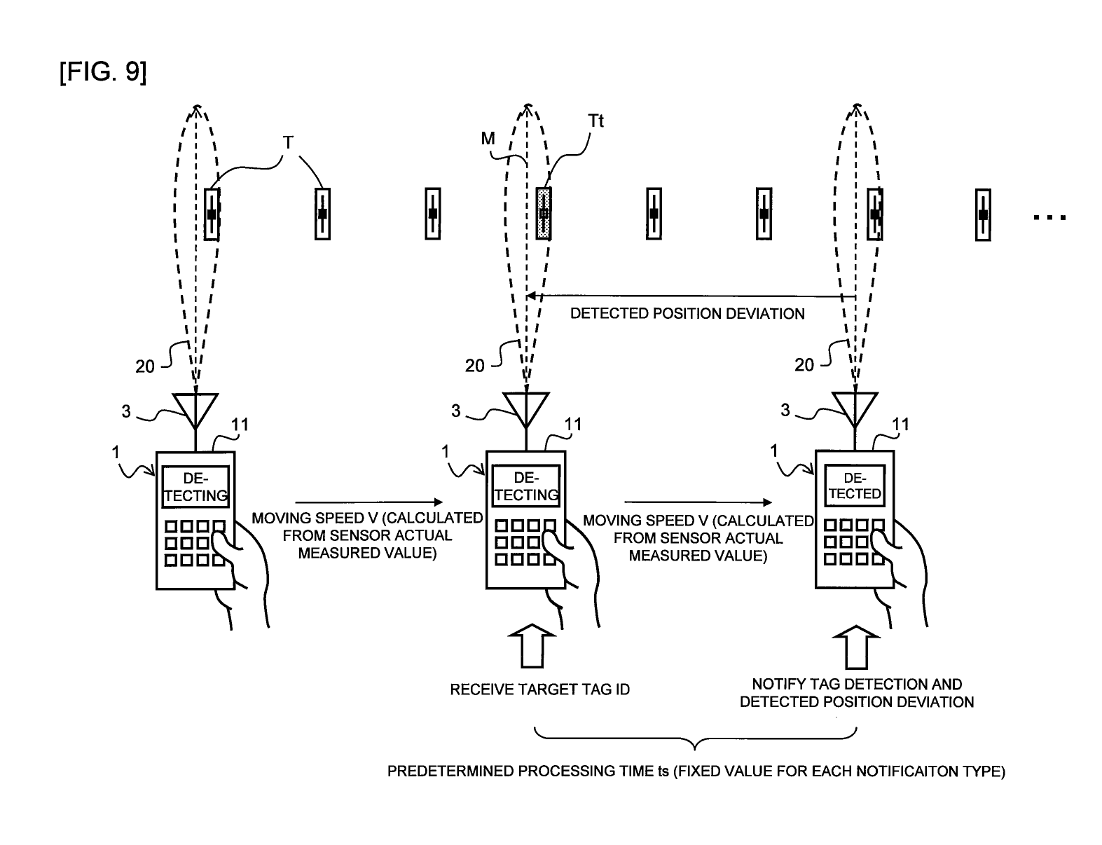

In the above embodiment, a time element used for the calculation of the detected position deviation, that is, the time from reception of the target tag ID to start of the notification operation is calculated by totaling the actual measured verification time tm and the predetermined notification time tc. On the other hand, as sown in FIG. 9 corresponding to FIG. 4, for example, as the time required for the entire processing form the reception of the target tag ID to the start of the notification operation, that is, a first time state amount, the predetermined processing time ts set in advance fixedly and stored may be used. In this case, the detected position deviation is calculated using the predetermined processing time ts.

This variation has the same hardware configuration as that of the above embodiment, and the same reference numerals are given to the equivalent portions and the description will be omitted as appropriate. The same applies to each of the following variations.

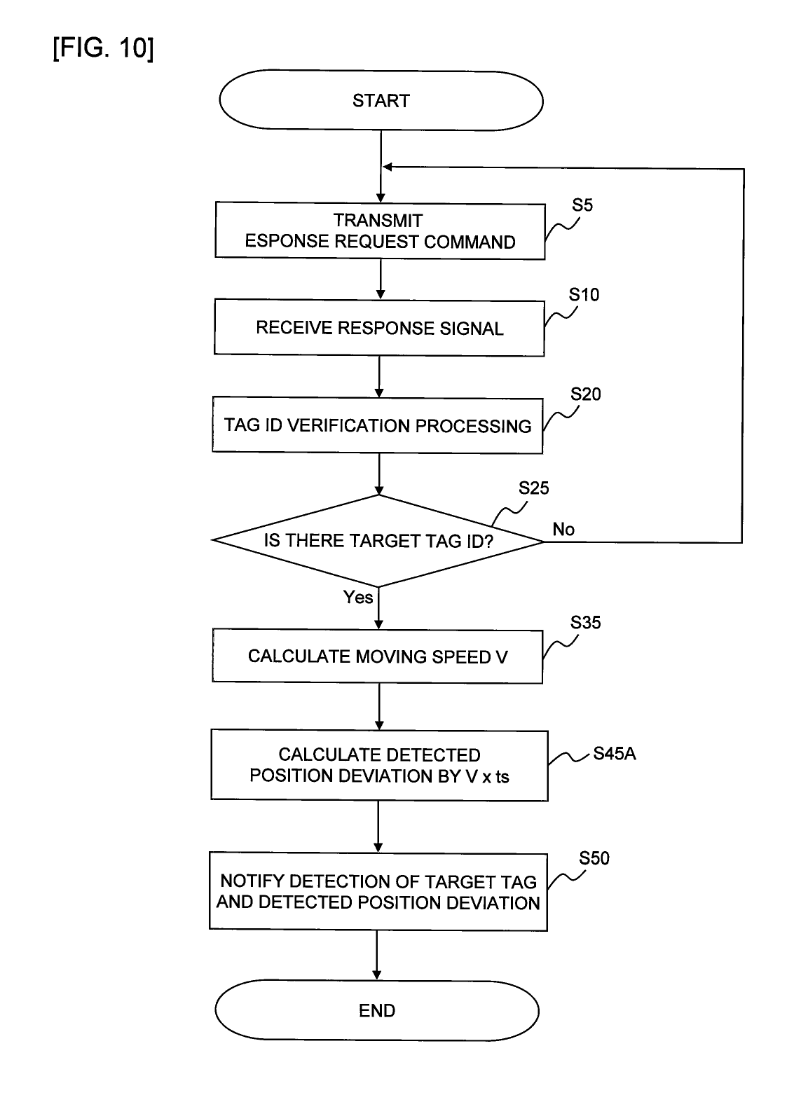

The control executed by the CPU 4 of the reader 1 in this variation will be described referring to FIG. 10. In the flow shown in FIG. 10, the procedures at Step S15, Step S30, and Step S40 relating to the operation of the timer 6 in the flow of FIG. 5 are omitted. Also, as the procedure for calculating the detected position deviation, Step S45A is provided instead of Step S45. At Step S45A, the CPU 4 integrates the moving speed V of the reader 1 calculated at Step S35 with the predetermined processing time ts, which is the fixed value, and calculates the detected position deviation. The calculation contents function as the direction calculation portion described in each claim. With regard to the predetermined processing time ts, the predetermined processing time ts, which is different according to the notification type of each notifying device, is set in advance in a fixed manner similarly to the predetermined notification time tc in the above embodiment.

The other configurations are the same as those in FIG. 5, and the description will be omitted.

In this variation configured as above, the detected position deviation is calculated using the predetermined processing time ts set in advance in a fixed manner corresponding to the notifying device. As a result, the detected position deviation can be calculated with a relatively simple method.

(2) If a Response Delay Time of the Operator is Considered:

In the above embodiment, the time element used for the calculation of the detected position deviation is set as only time from the reception of the target tag ID to the start of the notification operation. Moreover, after the notification operation is started, the notification may be made considering the response delay time till the operator notices the notification and stops the movement of the reader 1, that is, the operator stops arm swinging.

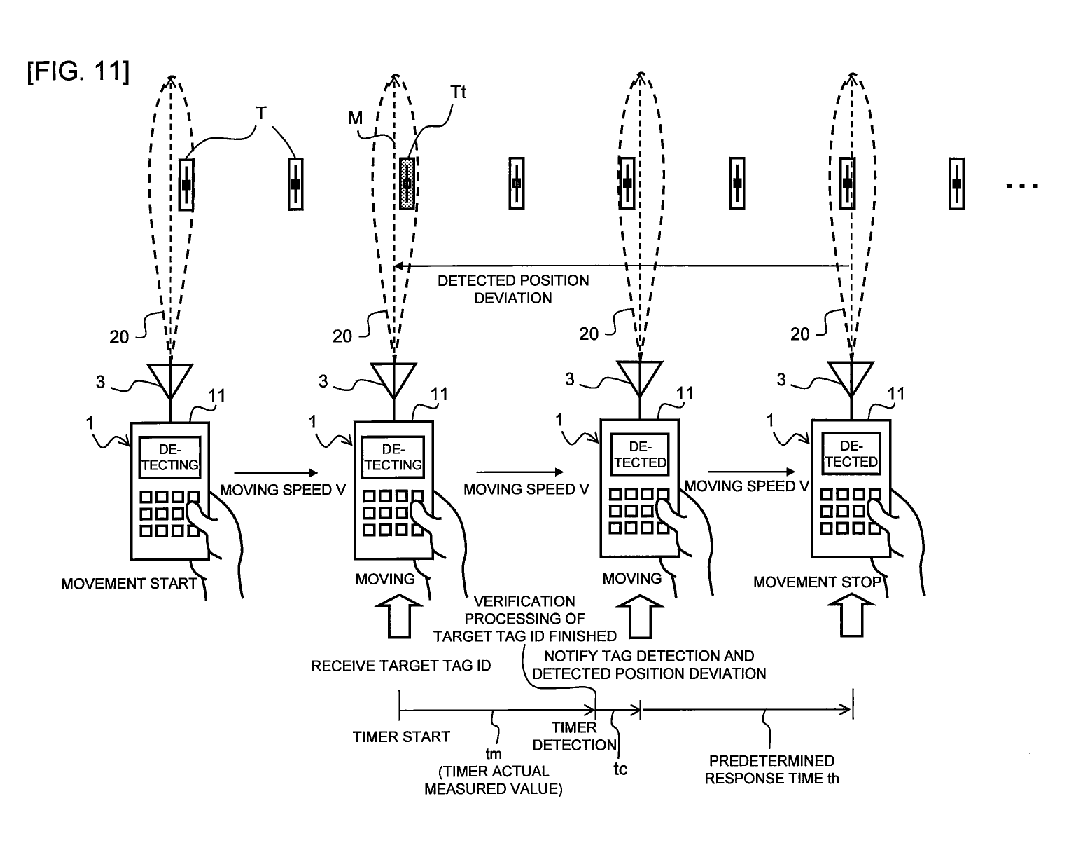

In this variation, as shown in FIG. 11 corresponding to FIG. 4, a predetermined response time th is set in advance as a second time state amount. This predetermined response time th is a response delay time estimated to be required till the operator confirms the notification and actually stops the movement of the reader 1 after the notification operation on the display part 8. In this variation, the detected position deviation is calculated on the basis of the time element including this response delay time.

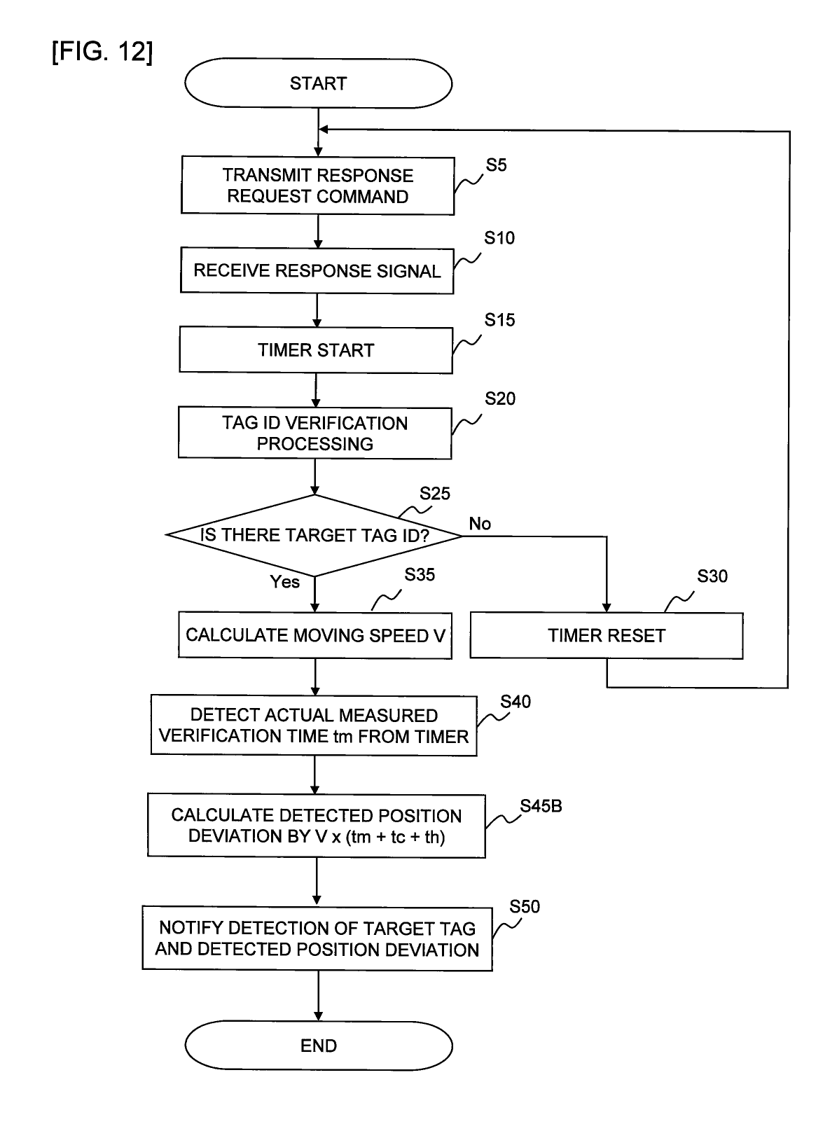

The control executed by the CPU 4 of the reader 1 in this variation will be described referring to FIG. 12. In the flow shown in FIG. 12, as the procedure for calculating the detected position deviation, Step S45B is provided instead of Step S45, which is a difference from FIG. 5. At Step S45B, the CPU 4 calculates the total time of the actual measured verification time tm detected at Step S40, the predetermined notification time tc set in advance in a fixed manner, and the predetermined response time th. Then, the CPU 4 acquires the detected position deviation by integrating the moving speed V of the reader 1 calculated at Step S35 with the total time. The calculation contents function as the direction calculation portion described in each claim. The predetermined response time th is set fixedly, assuming a user having a general perceptive faculty and motion capability. If plural types of notification are provided, different predetermined response times th are set fixedly to each of the notification types. That is, the operator inputs the notification type through the operation part 7 in advance, for example, and at Step S45B, the CPU 4 calculates the detected position deviation using the predetermined response time th corresponding to the selected notification type.

The other configurations are the same as those in FIG. 5, and the description will be omitted.

In this variation configured as above, the total time including the predetermined response time th corresponding to an elapsed time from when the operator notices the notification till the operator stops the movement of the reader 1 in addition to the actual measured verification time tm and the predetermined notification time tc is used to calculate the detected position deviation. As a result, the notification in which deviation till the movement stop after the notification is corrected can be made, and notification with higher accuracy can be made. Also, by setting the predetermined response time th according to the notification type, detailed detected position deviation can be notified, and convenience for the operator can be improved.

(3) If a Notification Check Operation is Performed:

In this variation, an operating device, not shown, such as a check operation button is disposed in the operation part 7. After the reader 1 notifies that the target tag Tt has been detected, the operator inputs that the notification is checked into the reader 1 using the check operation button.

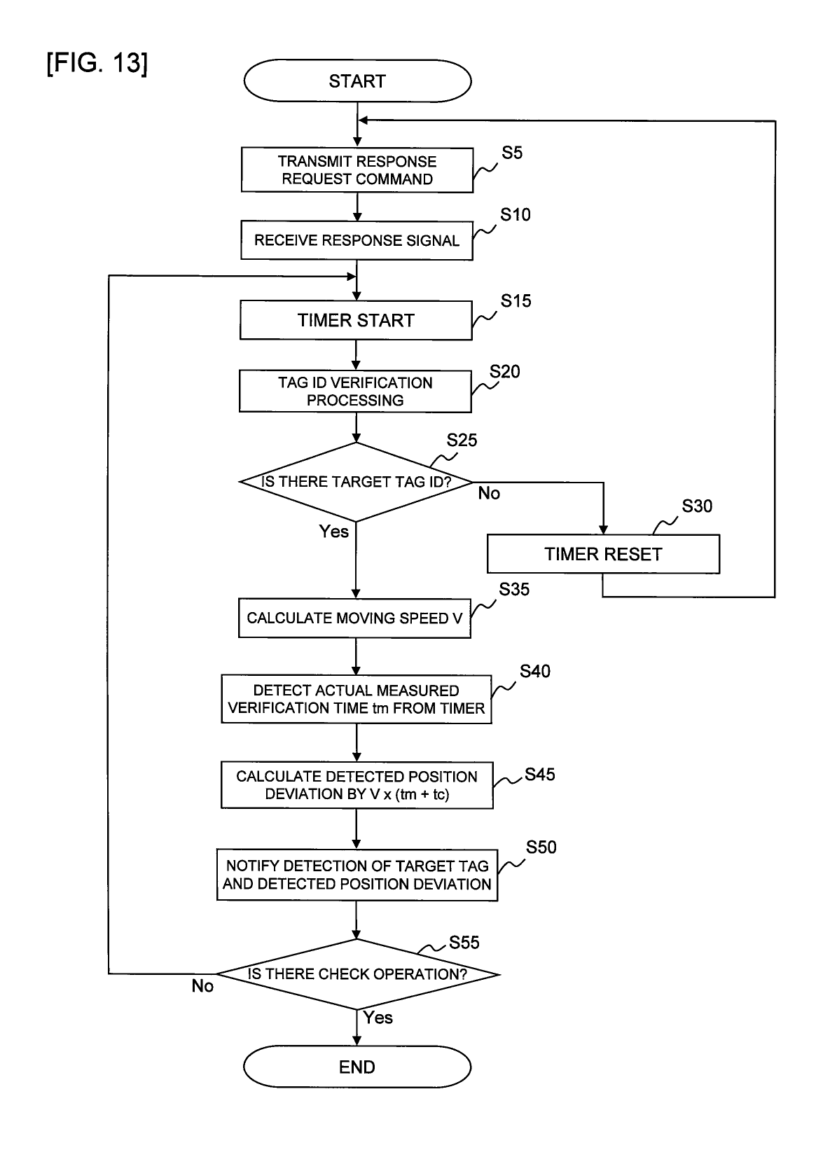

The control executed by the CPU 4 of the reader 1 in this variation will be described referring to FIG. 13. In the flow shown in FIG. 13, Step S55 to determine if an input of a check operation by the operator has been made or not is newly provided after Step S50, which is a difference from FIG. 5. At Step S55, if the check operation has not been performed, the determination is not satisfied, the routine returns to Step S15 and repeats the similar procedure from the timer start. If there has been a check operation, the determination at Step S55 is satisfied, and this flow is finished. The control contents function as the calculation control portion described in each claim.

The other configurations are the same as those in FIG. 5, and the description will be omitted.

In this variation configured as above, the operator can input the intention that the notification by the display part 8 was checked through an operation of the check operation button. If this operation input is made, the calculation of the detected position deviation is stopped. As a result, continuation of the wasteful calculation of the detected position deviation or mode notification corresponding to that can be prevented.

(4) Others

In the above, as an example of a movable apparatus for communicating with an RFID tag, the reader 1 of the handheld type which makes search by being carried by the operator in the hand is described but not limited to that. That is, the present invention can be applied to an apparatus for communicating with an RFID tag disposed in various types of robot or various types of movable equipment such as a vehicle and a conveyer, for example, and moving linearly, in an arc-state, and in a circular motion, for example. In these cases, the same advantages as above are obtained.

Other than those described above, the methods of the above-described embodiment and the variations may be combined as appropriate for use.

Though not specifically exemplified, the present invention should be put into practice with various changes made in a range not departing from its gist.

What is claimed is:

1. A apparatus for communicating with a radio frequency identification (RFID) tag of a movable type, comprising:
an apparatus antenna configured to conduct information transmission and reception with respect to an RFID tag circuit element having an IC circuit part storing information and a tag antenna connected to said IC circuit part;
a transmission processing portion configured to generate an inquiry signal for obtaining the information stored in said IC circuit part and transmits the signal via said apparatus antenna;
a reception processing portion configured to be able to receive a response signal replied from said RFID tag circuit element according to said inquiry signal via said apparatus antenna;
a notifying device configured to make notification to an operator according to a reception result by said reception processing portion; and
a notification control portion configured to control said notifying device so that the notification by said notifying device is in a mode corresponding at least to movement of said apparatus before the notification of the notifying device is started after the reception processing by said reception processing portion is performed.

2. The apparatus according to claim 1, further comprising a movement detecting device configured to detect a movement state amount relating to the movement of said apparatus.

3. The apparatus according to claim 2, wherein:
said notification control portion includes a direction calculation portion configured to calculate a direction state amount relating to a direction where the RFID tag circuit element that replied said response signal is present by means of using at least a first time state amount corresponding to an elapsed time from the reception processing by said reception processing portion to the start of notification and said movement state amount detected by said movement detecting device and
said notification control portion controls said notifying device so as to be in a mode corresponding to the direction state amount calculated by said direction calculation portion.

4. The apparatus according to claim 3, wherein:
said direction calculation portion calculates said direction state amount by means of using said first time state amount set in advance corresponding to said notifying device and said movement state amount detected by said movement detecting device.

5. The apparatus according to claim 4, wherein:
said direction calculation portion calculates said direction state amount by means of using said first time state amount selected corresponding to a notification type of said notifying device among a plurality of said first time state amounts and said movement state amount.

6. The apparatus according to claim 3, further comprising a time calculation portion configured to calculate said first time state amount corresponding to an elapsed time from the reception processing by said reception processing portion to the start of notification, wherein
said direction calculation portion calculates said direction state amount by means of using said first time state amount calculated by said time calculation portion and said movement state amount detected by said movement detecting device.

7. The apparatus according to claim 3, wherein:
said direction calculation portion calculates said direction state amount by means of using said first time state amount, a second time state amount corresponding to an elapsed time from when said operator notices the notification after the start of notification by said notifying device till the operator stops movement of said apparatus, and said movement state amount.

8. The apparatus according to claim 7, wherein:
said direction calculation portion calculates said direction state amount by means of using said second time state amount set in advance corresponding to said notifying device, said first time state amount, and said movement state amount.

9. The apparatus according to claim 8, wherein:
said direction calculation portion calculates said direction state amount by means of using said second time state amount set corresponding to a notification type of said notifying device, said first time state amount, and said movement state amount.

10. The apparatus according to claim 3, further comprising an operating device for an operator to make an input that the notification made by said notifying device has been checked.

11. The apparatus according to claim 10, further comprising a calculation control portion configured to stop new calculation of said direction state amount by said direction calculation portion if said input that the notification has been checked is made via said operating device.
